(19) United States
(12) Patent Application Publication
(10) Pub. No.: US 2016/0193961 A1
(43) Pub. Date: Jul. 7, 2016

(54) METHODS AND SYSTEMS FOR VISUAL COMMUNICATION OF VEHICLE DRIVE INFORMATION USING A LIGHT SET

(71) Applicant: MYINE ELECTRONICS, INC., Ferndale, MI (US)

(72) Inventors: Joel J. FISCHER, Royal Oak, MI (US); Justin DICKOW, Royal Oak, MI (US); Scott SMEREKA, Warren, MI (US); Joey Ray GROVER, Madison Heights, MI (US); Corey MAYLONE, Berkley, MI (US)

(21) Appl. No.: 14/589,452

(22) Filed: Jan. 5, 2015

(51) Int. Cl. B60Q 9/00; G08G 1/0965; G08G 1/0962

(52) U.S. Cl. CPC B60Q 9/008; G08G 1/09623; G08G 1/0965

(57) ABSTRACT

A vehicle computing system includes a plurality of sensors, one or more lights, and at least one controller used to notify a driver of a detected object. The plurality of sensors may be configured to detect and measure a distance to the detected object. The at least one controller may be configured to select a color for display at the one or more lights based on the detected object being within a first predefined distance. The at least one controller may be further configured to adjust a brightness intensity for the one or more lights based on the selected color and the distance to the detected object.

### TECHNICAL FIELD

The present disclosure relates to an illuminable display for use with a vehicle, in particular an illuminable display that provides vehicle operation information for an occupant of the vehicle.

### BACKGROUND

One conventional solution to address a vehicle blind spot has been to provide an indication light on an exterior mirror on a vehicle that is illuminated when a car is in the blind spot on that side of the exterior minor. While this solution is helpful to a driver, it may not be easily visible within the peripheral vision of the driver, particularly if a small light is illuminated on a passenger side mirror. Various other strategies have been used to communicate vehicle drive information, although they may result in diverting driver attention away from the road, or may not catch a driver's attention.

### SUMMARY

In at least one embodiment, a vehicle computing system having a plurality of sensors and at least one controller is configured to detect an object using the sensors. The plurality of sensors may include a sensor located in two or more places at a vehicle perimeter. The sensors may be configured to detect objects located near the vehicle. The at least one controller may be configured to determine a distance and location of one or more of the objects located near the vehicle based on information from the sensors. The at least one controller may be further configured to adjust a brightness intensity for the one or more lights based on the detected object within a first predefined distance. The at least one controller may be further configured to select a color for display by one or more lights based on the distance to the detected object.

In at least one embodiment, a light notification system for a vehicle includes a first light positioned near the top of a windshield. The system includes a navigation system, a plurality of sensors, and at least one controller configured to activate the light based on the navigation system and sensors. The at least one controller may be configured to receive vehicle drive data including at least one of navigation information having turn by turn directions via the navigation system, and object detection information via the plurality of sensors. The at least one controller may be further configured to activate a color and intensity of the first light based on the vehicle drive data.

In at least one embodiment, a vehicle includes a receiver configured to receive an alert signal from an emergency vehicle and at least one controller configured to enable one or more lights based on the alert signal. The at least one controller may be configured to calculate a direction and distance of the emergency vehicle using a global positioning system based on the alert signal. The at least one controller may be further configured to select a color and brightness for one or more lights based on the distance. The at least one controller may be further configured to activate one or more lights based on the direction to notify a driver of the emergency vehicle.

### BRIEF DESCRIPTION OF THE DRAWINGS

FIG. 1 is an exemplary block topology of a vehicle infotainment system implementing a user-interactive vehicle information display system;

FIG. 2A is a side view of a vehicle having a light notification system in communication with the vehicle computing system;

FIG. 2B is a plan view of a light set of the light notification system;

FIG. 3 is a top view of the vehicle having the light notification system;

FIG. 4 is a flow chart of a distance detection method using the light notification system;

FIG. 5 is a flow chart of a traffic stop detection method using the light notification method;

FIG. 6 is a flow chart of a navigation method using the light notification system; and

FIG. 7 is a flow chart of an emergency vehicle detection method using the light notification system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle infotainment system may output information that may assist the driver to operate the vehicle. The vehicle infotainment system may process information for display using a vehicle computer system. The output information may be displayed at a user screen, at a speaker, an instrument cluster, and a combination thereof. For example, navigation information may be presented to the driver using the display and/or the speaker. The amount of information being communicated to the driver may be improved with the use of a light notification system. The light notification system may be implemented to notify a driver of an object in a blind spot, provide navigation directions, coordinate traffic stop information, alert the driver of an oncoming emergency vehicle, and a combination thereof.

The light notification system may comprise one or more lights positioned within the vehicle cabin. The one or more lights may be configured in a light set. For example, the light notification system may output information based on the illumination of one or more light sets. The light notification system may output information via the one or more light sets based on adjusting the brightness of the illumination, the color of the light, and a combination thereof.

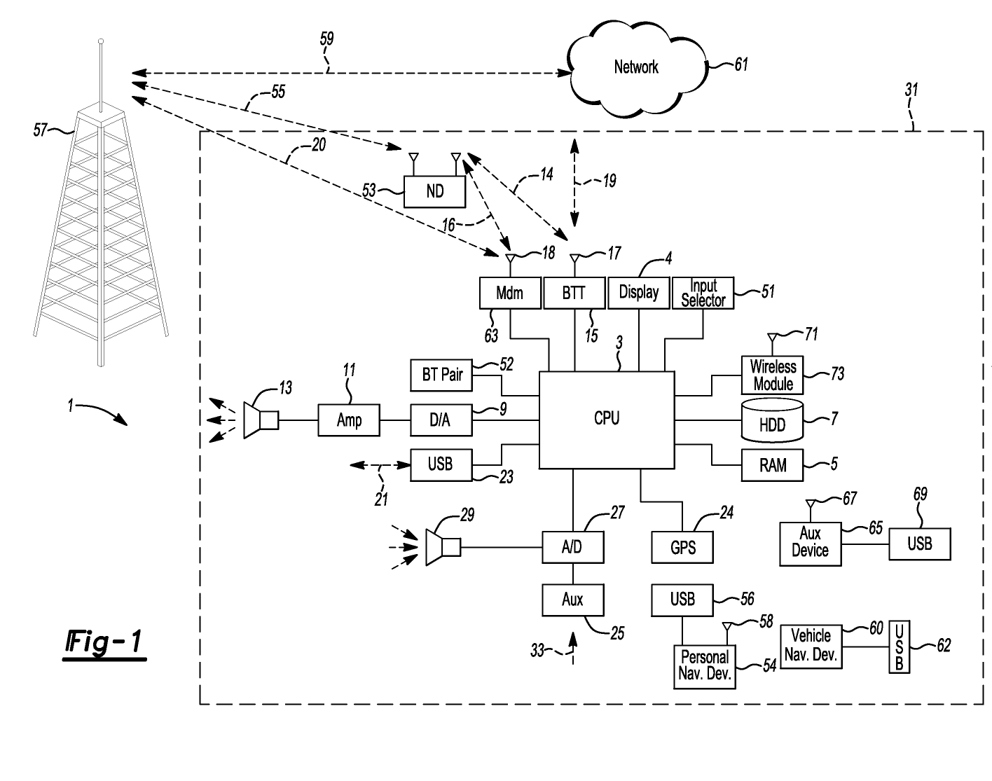

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof). For example, the light notification system (not shown) may be in communication with the VCS 1 via the vehicle network.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication. The system 1 may communicate the data received from the nomadic device and/or the additional sources to one or more outputs. The one or more outputs may include, but is not limited to, the display 4, speaker 29, the light notification system (not shown), and/or a combination thereof.

Further, the CPU could be in communication with a variety of other auxiliary devices 65. These devices can be connected through a wireless 67 or wired 69 connections. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

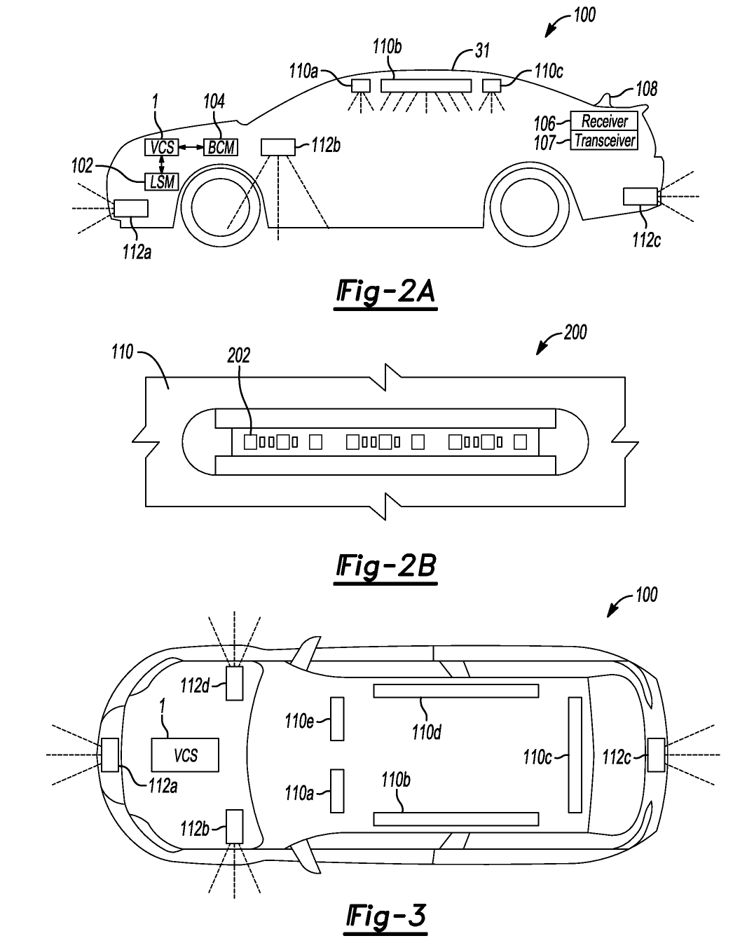

FIG. 2A is a side view of the vehicle 31 having a light notification system 100 in communication with the VCS 1. The light notification system 100 may comprise one or more control modules. The one or more control modules may include a light system module (LSM) 102, a body control module (BCM) 104, and/or a combination thereof. The one or more control modules may communicate with the VCS 1 using the vehicle network. The LSM 102 is shown as a separate component, however, it is understood that the LSM 102 may be integrated as part of the VCS 1 and/or BCM 104.

The LSM 102 may communicate with a receiver 106 having an antenna 108. The receiver 106 and antenna 108 may comprise any known receiving means that is capable of wireles sly receiving data signal and forwarding the received data signals to the LSM 102, VCS 1, and/or a combination thereof. For example, the receiver may receive data from other vehicles and communicate the data to the LSM 102. In another example, the receiver may receive data from a smart traffic light and/or stop sign and communicate the data to the LSM 102. A transceiver 107 may be used to communicate stop sign/traffic light information to other vehicle. The use of the transceiver 107 with the light notification system 100 will be further discussed below.

The light notification system 100 may comprise one or more light sets 110. The LSM 102 may control the light set 110 based on received information from the receiver 106 and antenna 108 and/or from one or more sensors 112. The one or more sensors 112 may include, but is not limited to, a proximity sensor, a radar sensor, a passive infrared sensor, an ultrasonic sensor, a smart sensor, and/or a combination thereof. The one or more sensors may detect an object based on techniques using sensor technology with the VCS. In one embodiment, the one or more sensors may include a camera system for detecting objects. The light notification system 100 may detect an object based on a predefined distance using the one or more sensors.

For example, the vehicle 31 may comprise a front proximity sensor 112a, a side proximity sensor 112b, and a rear proximity sensor 112c. In response to an object detection from the proximity sensor 112, the light notification system 100 may control a front light set 110a, a side light set 110b, a rear light set 110c, and/or a combination thereof. The VCS may detect an object near the vehicle using the one or more sensors. In one example, the one or more sensors may detect an object approximately six to forty-eight inches from the vehicle. If the VCS detects an object within twenty-four inches of the vehicle, the light notification system 100 may set the one or more lights to red. If the VCS detects an object within twenty-four to thirty-six inches of the vehicle, the light notification system may set the one or more lights to yellow. If the VCS detects an object greater than 36 inches from the vehicle, the light notification system may set the one or more lights to green.

In another example, in response to a traffic light (or stop sign) detection using at least one of the one or more sensors 112 and/or the receiver 106 and antenna 108, the light notification system 100 may control the light(s) within the one or more light sets 110. The receiver 106 and antenna 108 may also be used to receive emergency vehicle information such that the light notification system 100 may control the light set(s) 110 based on the direction of the oncoming emergency vehicle.

FIG. 2B is a plan view of a light set 110 of the light notification system 100. The light set 110 may comprise one or more light-emitting diodes (LEDs) 202. The one or more LEDs 202 may be capable of emitting a wide array of colors and intensities used to notify the vehicle occupants of certain situations.

For example, the light notification system 100 may receive data that the vehicle 31 is traveling within a safe distance behind another vehicle via one or more sensors 112; in response to this data, the system 100 may control the LED(s) 202 to emit a green light at a very low intensity or no light at all. As the vehicle 31 approaches the other vehicle within a distance that may not allow the brake system to stop the vehicle based on a vehicle speed, the light notification system 100 may increase the intensity of the light and the color may change from green to yellow. If the vehicle 31 stays within the distance for a predetermined amount of time, the light notification system 100 may change the LED(s) 202 from yellow to red at a higher intensity.

FIG. 3 is a top view of the vehicle 31 having the light notification system 100. As shown in FIG. 3, the VCS 1 may include one or more modules (e.g. , LSM 102, BCM 104, etc.) to control the light notification system 100. The light notification system 100 comprises one or more sensors 112 that may be positioned around the proximity of the vehicle 31. In response to the light notification system 100 receiving object detection data from the one or more sensors 112, the system 100 may control the one or more light sets 110 to a predetermined color and intensity setting.

The one or more light sets 110 may be may be integrated in the roof lining of the vehicle interior. In one example, the one or more light sets 110 may be positioned parallel to a window of the vehicle (e.g., at a top or side of a vehicle window). In another example, the one or more light sets 110 may be positioned near a top of a windshield, a rear window, a driver window, a passenger window, and/or a combination thereof.

For example, the light notification system 100 may receive data from a side proximity sensor 112d that an object is detected within a predefined distance. The light notification system 100 may control a side light set 110d and/or a front light set 110e based on the object detected via the side proximity sensor 112d. The light notification system 100 may track the detected object via the side proximity sensor 112d and control the light color and intensity of the side light set 110d and/or front light set 110e.

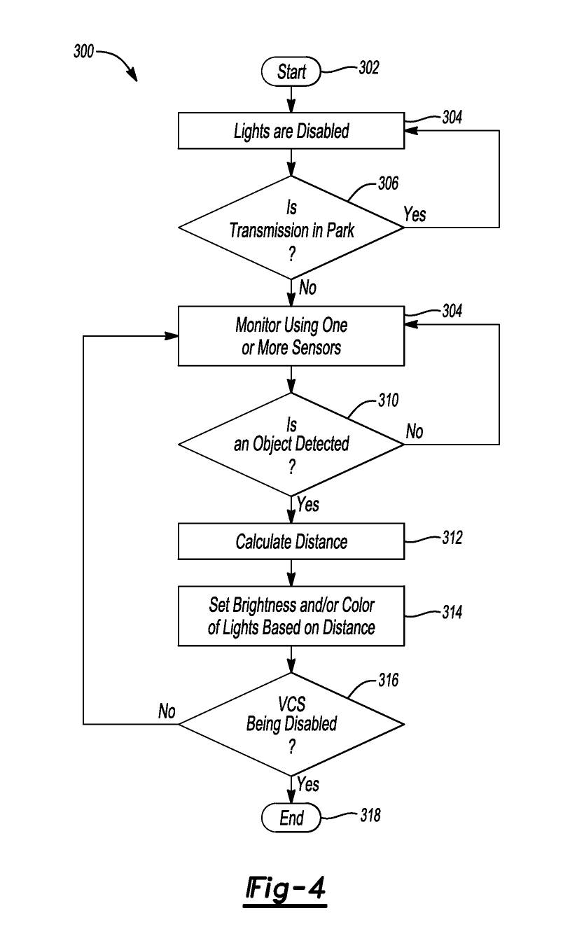

FIG. 4 is a flow chart of a distance detection method 300 using the light notification system 100. The method 300 may be implemented using software code contained within the VCS 1, LSM 102, BCM 104, and/or a combination thereof. In other embodiments, the method 300 may be implemented in other vehicle controllers, or distributed among multiple vehicle controllers.

Referring again to FIG. 4, the vehicle 31 and its components illustrated in FIG. 1, FIG. 2, and FIG. 3 are referenced throughout the discussion of the method to facilitate understanding of various aspects of the present disclosure. The method 300 of controlling one or more light sets 110 based on an object detected using a sensor 112 may be implemented through a computer algorithm, machine executable code, or software instructions programmed into a suitable programmable logic device(s) of the vehicle, such as the vehicle control module, the device control module, the LSM 102, BCM 104, another controller in communication with the vehicle computing system, or a combination thereof. Although the various operations shown in the flowchart diagram 300 appear to occur in a chronological sequence, at least some of the operations may occur in a different order, and some operations may be performed concurrently or not at all.

In operation 302, the light notification method 100 may be enabled by a start request received from one or more mechanisms including, but not limited to, a vehicle key, a vehicle key fob, a wireless device, and/or a combination thereof. The VCS 1 (and/or LSM 102) may initialize one or more applications for execution of the light notification method 300. In response to the initialization, the method 300 may disable the one or more light sets 110 in operation 304. For example, the light notification method 300 may be initialized with the light set 110 in a disabled state.

In operation 306, the light notification method 300 may check a gear position of a powertrain. If the powertrain is in a PARK position, the method may remain to disable the one or more light sets 110. If the powertrain is not in the PARK position, the method 300 may begin to monitor for an object using one or more sensors 112 in operation 308.

For example, the method 300 may use one or more sensors 112 positioned around the proximity of the vehicle 31 to sense an object within a predefined distance. The predefined distance is a calibratable value that is set based on the capabilities of the sensor 112. In another embodiment, the predefined distance may include a calibratable value based on the capabilities of object recognition software using a camera system.

In operation 310, the method 300 may check if an object is detected using the one or more sensors 112. If an object is not detected, and/or if the object is not within the predefined distance of the vehicle 31, the method 300 may continue to monitor for an object. If an object is detected, the method may calculate the distance of the object in operation 312.

In operation 314, in response to the distance of the detected object, the method may set a brightness and/or color of the lights. For example, the method may have a calibratable table comprising one or more distance values with a respective color and light intensity. The light color and intensity may be in direct response to the distance calculated by the method.

In another example, the method 300 may control the light notification system 100 using the following equation:

D_{A}<D_{B}=Lights On (1)

wherein D_{B} represents an actual distance between the vehicle 31 and the detected object and D_{A} represents an estimated braking distance of the vehicle 31 to the detected object. In response to equation (1), the method 300 may control whether to enable the light(s) 202 configured within the one or more light sets 110. The method 300 may control the intensity of the light notification system using the following equation:

Fₙ(D_{A}−D_{B})=Light Intensity (2)

wherein Fₙ is a light intensity value on the calibratable table based on the difference of D_{A} (the estimated braking distance of the vehicle to the detected object) and D_{B} (the actual distance between the vehicle and the detected object).

In operation 316, the method 300 may check to determine if the VCS 1 is being requested to enable a shutdown state. If the VCS 1 is not being requested to shutdown, the method 300 may continue to monitor for an object. If the VCS 1 is being requested to shutdown, the method 300 may begin to shutdown while storing one or more parameters/settings related to the one or more applications for the light notification system 100 in non-volatile memory in operation 318.

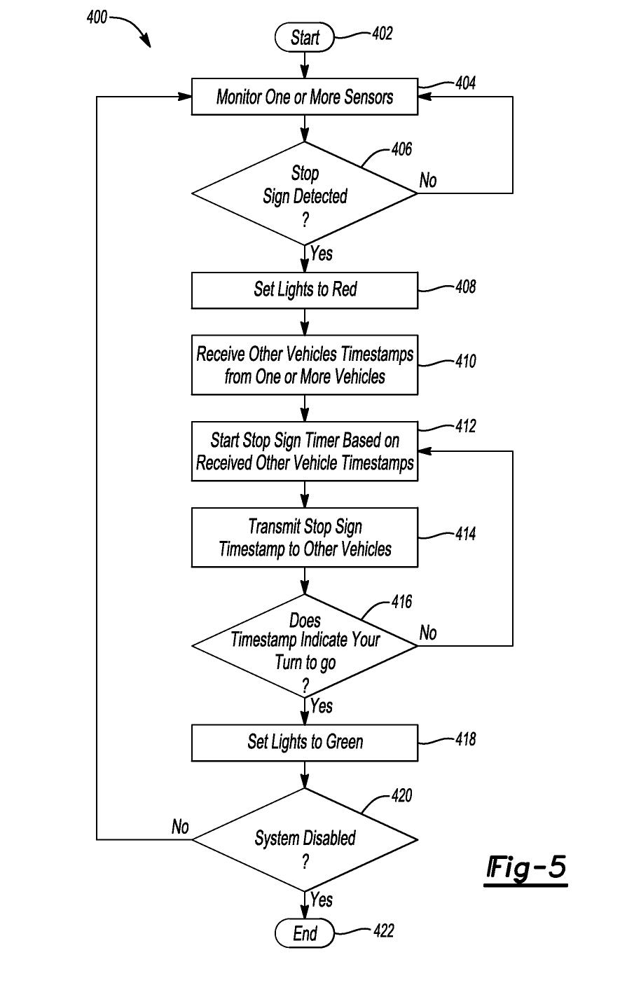

FIG. 5 is a flow chart of a traffic stop detection method 400 using the light notification system 100. The method 400 may be implemented using software code contained within the VCS 1, LSM 102, BCM 104, and/or a combination thereof. In other embodiments, the method 400 may be implemented in other vehicle controllers, or distributed among multiple vehicle controllers.

In operation 402, the light notification method 400 may initialize one or more applications for execution at one or more modules within the light notification system 100. In response to the initialization, the method 400 may monitor one or more sensors 112 to look for a stop sign in operation 404.

In operation 406, the method 400 may determine if a stop sign is detected using the one or more sensors 112. If a stop sign has not been detected, the method 400 may continue to monitor for a stop sign. If a stop sign has been detected, the method 400 may enable the one or more light sets 110 in operation 408.

For example, if the method 400 detects a stop sign within a predefined distance, the VCS 1 may control the light set 110 to a red color with low intensity. If the method 400 detects that the stop sign is exceeding an estimated braking distance value based on the distance to the stop sign, the VCS 1 may control activation of the light set to a red color with a higher intensity.

In operation 410, the method 400 may receive timestamp(s) from other vehicle(s) at an intersection of the stop sign. The timestamp(s) may be received using the receiver 106 and antenna 108 configured to communicate with the VCS 1. The method 400 may start a stop sign timer based on the received timestamp(s) from the other vehicle(s) in operation 412.

For example, if the light notification system 100 receives one or more timestamps via the receiver 106, the method 400 may start a timer based on the one or more timestamps to notify the vehicle 31 of the order it is in between the other vehicles at the intersection. The method 400 may generate a new timestamp based on the timer and the one or more timestamps. The method 400 may transmit the new timestamp to the other vehicles at the intersection via the transceiver 107 and antenna 108 in operation 414.

In operation 416, the method 400 may monitor the timer to determine when the light notification may enable the one or more light sets to indicate that it may be the vehicle's turn to go, i.e., the vehicle has the right-of-way. In response to the timer indicating that the vehicle 31 may have the right-of-way at the multi-way stop, the method 400 may transmit a request to enable the light set 110 to emit a green color in operation 418.

For example, in response to the vehicle 31 approaching a four-way stop, the method 400 may enable the front light sets 110a 110e to emit a red color. At the four-way stop, the system 100 may receive one or more timestamps from the other vehicles at the intersection (e.g., three vehicles located at the other stop signs at the four-way stop intersection). In response to the one or more timestamps, the method 400 may start a timer to notify the driver of his/her order at the four-way stop. The method 400 may generate a new timestamp based on the timer and the received one or more timestamps from the other vehicles. The method 400 may transmit the new timestamp to other vehicles at the four-way stop. In response to the timer indicating the vehicle 31 has the right-of-way, the method 400 may transmit a request to enable the front light sets 110a, 110e to emit a green color.

In another example, in response to the vehicle 31 approaching a traffic light, the receiver 106 and antenna 108 may receive a traffic light status from a smart traffic light. The method 400 may control the light set 110 based on the traffic light status. For example, if the traffic light status indicates that the traffic light may remain in a green state in enough time for the vehicle 31 to pass, the method 400 may enable the light set 110 to emit a green color. In another example, if the traffic light status indicates that the traffic light is in a red or yellow state, the method 400 may enable the light set 110 to emit either a red or yellow color, respectively.

In operation 420, the method 400 may check to determine if the VCS 1 is being requested to enable a shutdown state. If the VCS 1 is not being requested to shutdown, the method 400 may continue to monitor for a stop sign and/or a traffic light. If the VCS 1 is being requested to shutdown, the method 400 may begin to shutdown while storing one or more parameters/setting related to the one or more applications for the light notification system 100 in non-volatile memory in operation 422.

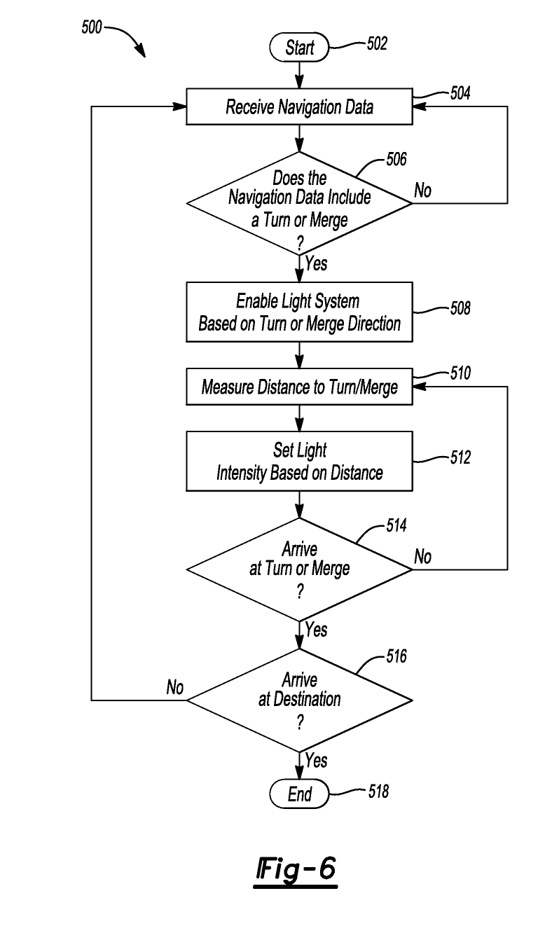

FIG. 6 is a flow chart of a navigation method using the light notification system 100. The method 500 may be implemented using software code contained within the VCS 1, LSM 102, BCM 104, GPS 24, and/or a combination thereof. In other embodiments, the method 500 may be implemented in other vehicle controllers, or distributed among multiple vehicle controllers.

In operation 502, the light notification method 500 may initialize one or more applications for execution at one or more modules within the light notification system 100. In response to the initialization, the method 500 may receive navigation data from a navigation system (i.e., GPS 24) in operation 504.

In operation 506, the method 500 may receive navigation data including an upcoming turn or a merge. If the navigation data does not include an upcoming turn or merge, the method 500 may continue to receive navigation data. If the navigation data does include an upcoming turn and/or merge, the method 500 may prepare the one or more light sets 110 to activate based on the upcoming turn and/or merge directions in operation 508.

In operation 510, the method 500 may calculate the distance to the turn and/or merge and increase the intensity or change the color of the one or more activated light sets 110. For example, if the navigation data indicates a right turn is needed within three hundred feet, the method 500 may activate the side light set 110d and/or the front light set 110e to emit a green color at a low intensity. The side light set 110d activated may be used as a visual indication to the driver that a right turn is coming up. As the vehicle 31 gets closer to the right turn, the method 500 may increase the intensity of the brightness at the side light set 110d and/or front light set 110e in operation 512.

In operation 514, the method 500 may monitor the navigation data to determine if the vehicle 31 has arrived at the turn and/or merge. If the vehicle 31 has not yet arrived at the turn, the method 500 may continuously measure the distance to the turn and/or merge to determine the light intensity. In another example, if the method 500 receives navigation data indicating that the vehicle 31 has passed the turn and/or merge, the method 500 may activate the side light set 110d and/or front light set 110e to emit a red color to inform the driver of the missed turn/merge.

In operation 516, in response to receiving navigation data that verifies that the vehicle 31 made the necessary turn and/or merge, the method 500 may determine if the vehicle 31 arrived at the predefined destination. If the vehicle 31 has not arrived at the destination, the method 500 may continue to receive navigation data to assist the driver on upcoming turns and/or merges using the light notification system 100.

In operation 518, if the vehicle 31 arrived at the destination, the method 500 may check to determine if the VCS 1 is being requested to enable a shutdown state. If the VCS 1 is not being requested to shutdown, the method 500 may continue to receive navigation data. If the VCS 1 is being requested to shutdown, the method 500 may begin to shutdown while storing one or more parameters/settings in non-volatile memory related to the one or more applications for the light notification system 100.

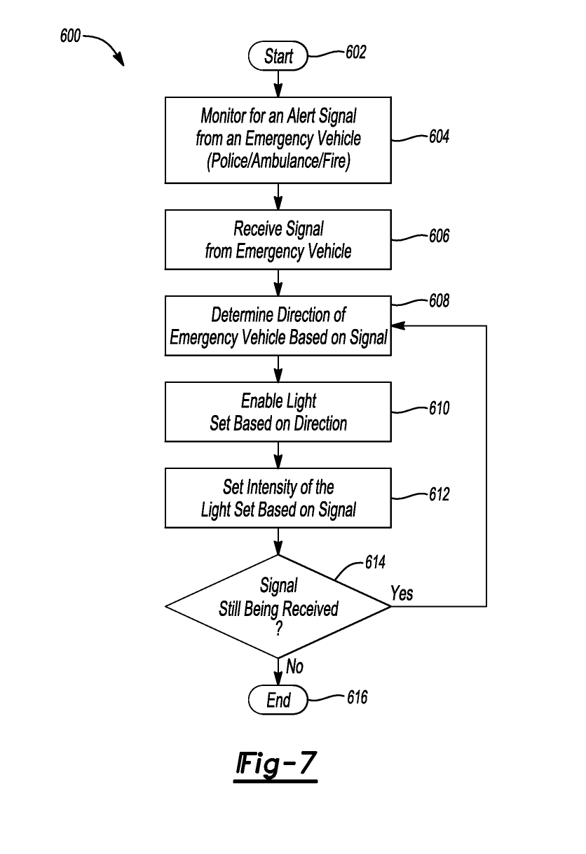

FIG. 7 is a flow chart of an emergency vehicle detection method 600 using the light notification system 100. The method 600 may be implemented using software code contained within the VCS 1, LSM 102, BCM 104, and/or a combination thereof. In other embodiments, the method 600 may be implemented in other vehicle controllers, or distributed among multiple vehicle controllers.

In operation 602, the light notification method 600 may initialize one or more applications for execution at one or more modules within the light notification system 100. In response to the initialization, the method 600 may monitor for an alert signal from an emergency vehicle (e.g., police, ambulance, fire, etc.) in operation 604.

In operation 606, the method 600 may receive a signal from an emergency vehicle via the receiver 106 and antenna 108. The method may determine an oncoming direction of the emergency vehicle based on the signal in operation 608.

For example, the alert signal may comprise a GPS location of the emergency vehicle. In response to the received GPS location, the method 600 may determine the current location of the vehicle 31 via the navigation system (i.e., GPS 24) and compare it to the received emergency vehicle GPS.

In operation 610, the method 600 may enable one or more light sets 110 based on the alert signal. The method 600 may also calculate the distance from the emergency vehicle to the vehicle 31 based on the received alert signal. In response to the distance from the emergency vehicle, the method 600 may set a color and/or an intensity of brightness for the light set 110 in operation 612.

For example, the light notification system 100 may receive the alert signal from an approaching ambulance via the receiver 106 and antenna 108. The method 600 may process the alert signal to determine the color and/or brightness intensity that should be enabled at the one or more light sets 110. In response to the alert signal, the method 600 may determine the ambulance is approaching from the rear of the vehicle 31. The method 600 may monitor if the vehicle 31 is clear to move over on the right to allow the ambulance to pass. If there is an object (e.g., other vehicle) at the right of the vehicle 31, the method may activate the rear light set 110c for the oncoming ambulance, and the side light set 110d for the detected object. The light notification system 100 allows the driver to safely pull over the vehicle 31 to allow the ambulance to pass within a reasonable amount of time.

In operation 614, the method 600 may determine if the emergency signal is still being received via the receiver 106. If the alert signal is still being received by the system 100, the method 600 may continue to determine the direction and distance the emergency vehicle is approaching the vehicle 31. If the receiver 106 is no longer receiving the alert signal, the system 100 may end the emergency detection vehicle method 600.

In operation 616, the method 600 may check to determine if the VCS 1 is being requested to enable a shutdown state. If the VCS 1 is not being requested to shutdown, the method 600 may continue to monitor for an emergency vehicle signal. If the VCS 1 is being requested to shutdown, the method 600 may begin to shutdown while storing one or more parameters/setting related to the one or more applications for the light notification system 100 in non-volatile memory.

The methods and systems disclosed herein provide various embodiments to improve the communication of driver information using the light notification system 100. The VCS 1 may be configured to detect objects using one or more sensors around the proximity of the vehicle and communicate the position of the detected object using the light notification system. The light notification system 100 may also communicate navigation destination directions while allowing the driver to keep their eyes on the road instead of looking at the navigation system screen.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle computing system comprising:
a plurality of sensors, located about a vehicle perimeter, the sensors configured to detect objects located near the vehicle; and
at least one controller configured to
determine a distance and location of one or more of the objects located near the vehicle based on information from the sensors,
in response to a detected object within a first predefined distance, select a color for display at one or more lights, and
adjust a brightness intensity for the one or more lights based on the selected color and the distance to the detected object.

2. The vehicle computing system of claim 1, wherein the plurality of sensors is at least one of a proximity sensor, ultrasonic sensor, radar sensor, a smart sensor, and a camera system.

3. The vehicle computing system of claim 2, wherein the one or more lights are near a front windshield and aligned parallel to at least one side of the front windshield.

4. The vehicle computing system of claim 2, wherein the one or more lights are near a rear window and aligned parallel to at least one side of the rear window.

5. The vehicle computing system of claim 2, wherein the one or more lights are near at least one of a driver window and a passenger window, and aligned parallel to at least one side of the at least one driver and passenger window.

6. The vehicle computing system of claim 5, wherein the at least one controller is further configured to, in response to the detected object on a driver side of a vehicle, enable the one or more lights at the driver window.

7. The vehicle computing system of claim 1, wherein the one or more lights are positioned in a roof lining of a vehicle cabin.

8. The vehicle computing system of claim 1, wherein the at least one controller is further configured to
if the distance of the detected object is within the first predefined distance, activate the one or more lights to the color of yellow, and
if the detected object is within the first predefined distance for a calibratable amount of time, increase the brightness of the one or more lights.

9. The vehicle computing system of claim 1, wherein the at least one controller is further configured to
if the distance of the detected object is within a second predefined distance, set the one or more lights to the color of red, and
if the detected object is within the second predefined distance for a calibratable amount of time, increase the brightness of the one or more lights.

10. A light notification system comprising:
a first light positioned near a top of a windshield;
a navigation system;
a plurality of sensors; and
at least one controller configured to
receive vehicle drive data including at least one of navigation information having turn by turn directions via the navigation system and object detection information via the plurality of sensors, and
activate a color and intensity of the first light based on the vehicle drive data.

11. The light notification system of claim 10, wherein the navigation information is driving directions to a destination.

12. The light notification system of claim 11, further comprising
a second light near a driver window;
a third light near a passenger window; and
wherein the at least one controller is further configured to receive an upcoming turn notification from the driving directions, and in response to the upcoming turn notification, set the color of at least one of the first, second, or third light.

13. The light notification system of claim 10, wherein the navigation information is stop sign information.

14. The light notification system of claim 13, further comprising a receiver and an antenna, wherein the at least one controller is further configured to
receive the stop sign information to detect a four way stop sign intersection,
begin a stop sign timer based on the detection of the four way stop sign,
receive a first timestamp from one or more cars at the four way stop via the receiver and antenna,
compare the stop sign timer to the first timestamp from the one or more cars,
generate a second timestamp based on the stop sign timer and the first timestamp, and
enable the first light based on the second timestamp.

15. The light notification system of claim 14, further comprising a transceiver, wherein the at least one controller is further configured to transmit the second timestamp to the one or more vehicles via the transceiver.

16. The light notification system of claim 10, further comprising
a receiver configured to receive traffic signal information; and the at least one controller further configured to set the color and brightness of the first light set based on the traffic signal information.

17. A vehicle comprising:
a receiver configured to receive an alert signal from an emergency vehicle; and
at least one controller configured to,
in response to the alert signal, calculate a direction and distance of the emergency vehicle using a global position system,
select a color and brightness for one or more lights based on the distance; and
activate the one or more lights based on the direction to notify a driver of the emergency vehicle.

18. The vehicle of claim 17, wherein the alert signal includes a current global position of the emergency vehicle.

19. The vehicle of claim 17, wherein the one or more lights are at least one of a first light near a front windshield, a second light near a rear window, a third light near a driver window, and a fourth light near a passenger window.

20. The vehicle of claim 19, further comprising
a plurality of sensors, each sensor located in two or more places at a vehicle perimeter, the sensors configured to detect objects located near the vehicle; and
wherein the at least one controller is further configured to
determine one or more of the objects located near the vehicle based on information from the sensors, and
in response to a detected object within a first predefined distance, select a color for display to at least one of the first, second, third and fourth light.

21. The vehicle of claim 17, wherein the one or more lights are within an interior of the vehicle outside of an instrument panel.
